(19) United States
(12) Patent Application Publication
(10) Pub. No.: US 2012/0316988 A1
(43) Pub. Date: Dec. 13, 2012

(54) METHOD AND SYSTEM FOR ONLINE SEARCHING AND PURCHASING OF MULTIPLE PRODUCTS SIMULTANEOUSLY

(76) Inventor: KEITH LAMPERT, HOLLYWOOD, FL (US)

(21) Appl. No.: 13/495,694

(22) Filed: Jun. 13, 2012

Related U.S. Application Data
(60) Provisional application No. 61/496,340, filed on Jun. 13, 2011.

(51) Int. Cl. G06Q 30/06

(52) U.S. Cl. 705/26.8

(57) ABSTRACT

A system and method for searching for multiple products simultaneously on the Internet is provided. The system identifies a plurality of optimum purchasing alternatives based on predetermined criteria and allows the consumer to select amongst the purchasing alternatives to purchase the desired products.

### CROSS-REFERENCE TO RELATED APPLICATIONS

The present application claims priority to: co-pending Provisional Patent Application No. 61/496,340, filed on Jun. 13, 2011, entitled “Method and System for Online Searching and Purchasing of Multiple Products Simultaneously”; that application being incorporated herein, by reference, in its entirety.

### BACKGROUND OF THE INVENTION

1. Field of the Invention

The present invention relates to Internet product searching and purchases and, more particularly, to a system for searching for multiple products simultaneously on the Internet, identifying optimum purchasing alternatives based on predetermined criteria and allowing the consumer to select amongst the purchasing alternatives and purchase the desired products.

2. Description of the Related Art

With the proliferation of the Internet and e-commerce, online shopping has become the norm for many people. Even people that still prefer to purchase goods in stores will frequently search online first to find the best available price. When the consumer is shopping for more than one product, the online shopping process can be time consuming and may not result in the lowest available cost due to limitations with the systems currently available.

Typically, when shopping for multiple products, the consumer will search for each product one at a time. There are several different methods commonly used by consumers today to shop for multiple products.

Some consumers have one or more preferred vendors in mind and will go directly to those vendor's websites, one at a time, and will search for each product being shopped, one at a time. If the consumer locates the first product being searched on the first vendor's website and the price is acceptable, the consumer will place that product in the online shopping cart. The consumer will then search that vendor's website for the second product on the shopping list and, if that product is available online from that vendor and the price is acceptable, the consumer will place that product in the online shopping cart. The consumer will then repeat that process on the first vendor's website, one product at a time, for the remaining products on the shopping list.

If all of the products sought by the consumer are not available on the first vendor's website or if the consumer believes that lower prices for one or more products might be available from other vendors, the consumer will visit websites for multiple vendors and will continue searching, one product at a time, until all of the desired products are found. This one vendor at a time, one product at a time process is time consuming and may not result in the lowest available prices, per unit and/or aggregate items, because the search is limited to the particular vendor websites visited. Additionally, this process may involve multiple purchases from multiple vendors, which results in the consumer having to track multiple shipments and may result in the consumer incurring multiple shipping charges, and wasting time and effort.

Another commonly used method is to visit a marketplace website, such as amazon.com. Although the marketplace website may avoid the need to visit individual vendor websites, the consumer will still have to search for the desired products one product at a time. Again, this one product at a time approach is time consuming and leaves the consumer to analyze all of the various product/vendor permutations to figure out what combination of vendor purchases will result in the lowest aggregate cost, considering both product and shipping costs. Also, the consumer must manually note and consider each vendor's rating to determine the risk of purchasing from such vendor, and lower cost alternatives may exist on the Internet at large.

Another commonly used method is to conduct a general online search for the products, which will lead the consumer to specific vendor websites or to a marketplace website and results in the same deficiencies previously discussed with respect to those methods.

Patented and unpatented systems have been developed to address the deficiencies described above and improve the efficiency of the online shopping process. One such system is BatchSearch (www.batchsearch.com). BatchSearch allows consumers to input a shopping list and the BatchSearch system will then search for the products on a limited number of websites that are designated by the consumer. BatchSearch will then present to the consumer a grid listing the prices for each of the products on each of the selected websites. Although the BatchSearch system avoids the need to visit each vendor website one at a time to search for each product one at a time, it still has several deficiencies. Specifically, BatchSearch only searches a limited number of vendor websites and the websites must be identified by the consumer. As a result, vendor websites not known or not listed by the consumer will not be searched and lower product prices may be overlooked. Additionally, the BatchSearch system output is a grid listing the prices for each of the products on each of the selected websites. As a result, the consumer still must analyze all of the various product/vendor permutations to figure out what combination of vendor purchases will result in the lowest aggregate cost, considering both product and shipping costs.

U.S. Pat. No. 7,120,595 (the “'595 Patent”) discloses a method and system for providing online comparison shopping. Under the 595 Patent, the user inputs his or her shopping list and specific optimization criteria. The optimization criteria can include lowest total cost, shipment methods and delivery time, among others. Using the consumer's inputs, the system disclosed by the '595 Patent generates an “optimal” shopping order. The system and method disclosed by the '595 Patent then requires the user to input modifications to the shopping list or optimization criteria and request that the system only recalculate the total cost for the order. The system and method disclosed by the '595 Patent still has many deficiencies. Specifically, it presents the consumer with only one purchase alternative at a time, which does not enable the consumer to compare the purchase order presented with other purchasing alternatives. The '595 Patent does not disclose or suggest providing the consumer with different purchase alternatives from which the purchaser may select the desired alternative. The '595 Patent also does not disclose or suggest evaluating all of the different product and vendor combinations to provide the consumer with the lowest possible cost for the fewest possible purchase transactions. Additionally, it requires that the consumer identify and input the optimization criteria to be initially considered by the system in determining the “optimal” shopping order. However, relevant criteria may not be thought of and designated by the consumer. As a result, criteria not thought of by the consumer will not be considered by the system and a true “optimal” shopping list may not be generated. Also, in today's environment in which consumers want quick results without having to put in much effort, the need to input initial optimization criteria, modifications to the shopping order and a request that the system perform only a recalculation of the total cost of the shopping order is time consuming and burdensome and may not be desirable to many consumers.

Accordingly, there is a need in the art for a method and system that simplifies the online shopping experience for consumers and produces true “optimal” alternative purchase options for each consumer. Any such system should be capable of searching all available online information and evaluating all of the different product and vendor combinations to provide the consumer with the lowest possible cost for the fewest possible purchase transactions with vendors having acceptable ratings. The system should also provide the consumer with different purchase alternatives from which the purchaser may elect the desired alternative. The present invention is particularly suited to overcome those problems which remain in the art in a manner not previously known.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an exemplary embodiment that is presently preferred, it being understood however, that the invention is not limited to the specific methods and instrumentality's disclosed. Additionally, like reference numerals represent like items throughout the drawings. In the drawings:

FIG. 1 is a block diagram of a system in accordance with one particular embodiment of the invention;

FIG. 2 is a flow chart illustrating one particular embodiment for a method in accordance with the present invention; and

FIG. 3 is a simplified diagram illustrating a workflow in accordance with one particular embodiment of the invention.

### DETAILED DESCRIPTION OF THE PREFERRED EMBODIMENT

Before explaining the disclosed embodiment of the present invention in detail, it is to be understood that the invention is not limited in its application to the details of the particular arrangement shown since the invention is capable of other embodiments. Also, the terminology used herein is for the purpose of description and not of limitation.

The present invention is directed towards a new and improved method and system for shopping for products online.

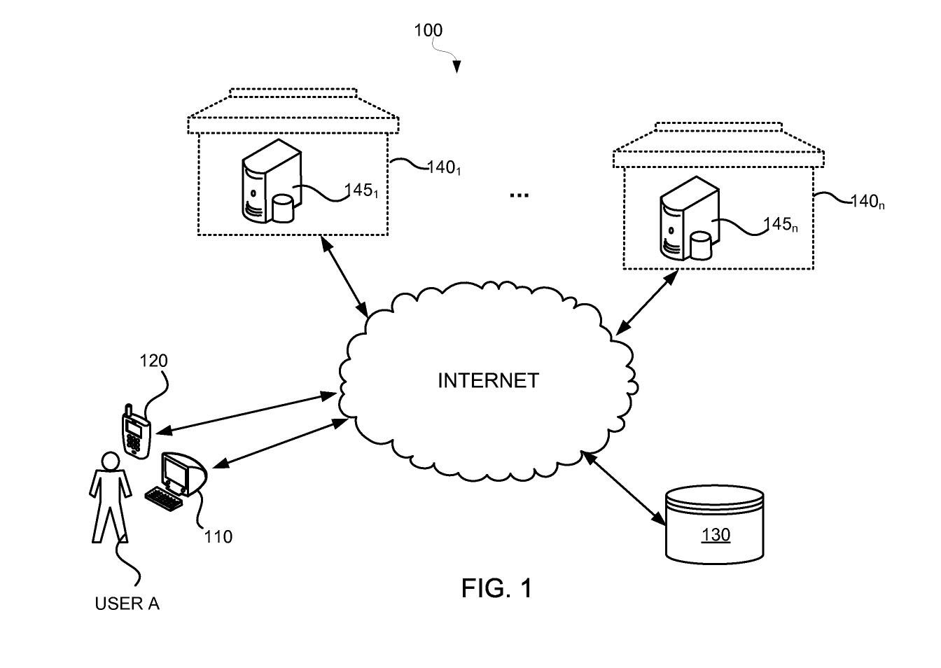

Referring now to FIGS. 1-3, there will be described a system and method in accordance with one particular embodiment of the present invention. More particularly, a first user, USER A, is interested in buying multiple items through the Internet. To start the process, USER A accesses the system 130 through the Internet using an Internet enabled device, such as a computer 110 or mobile phone 120. Note that other Internet enabled devices, such as laptop computers, smartphones, tablets, etc., may be used by USER A to connect to the system 130. The system 130 is embodied in software, hardware and/or code. In one particularly preferred embodiment of the invention, the system 130 is embodied in computer code or software stored in a computer memory device and executed by a processor of a computer or server of the system 130, that is accessible through a web page via the Internet. The system 130 accepts inputs from a user, via an online form presented by the website, and performs searches over the Internet based on the inputs from the user and computer-based calculations on the results. More particularly, the system 130 performs searches, also via the internet, to locate products available through online vendors 140₁ . . . 140ₙ, wherein “n” is an unlimited number of online vendors that offer products online. Subsequently, and in dependence on information input by the remote user, USER A, the system 130 will refine the search and/or will generate a report or invoices that will provide a plurality of optimized purchase options to USER A.

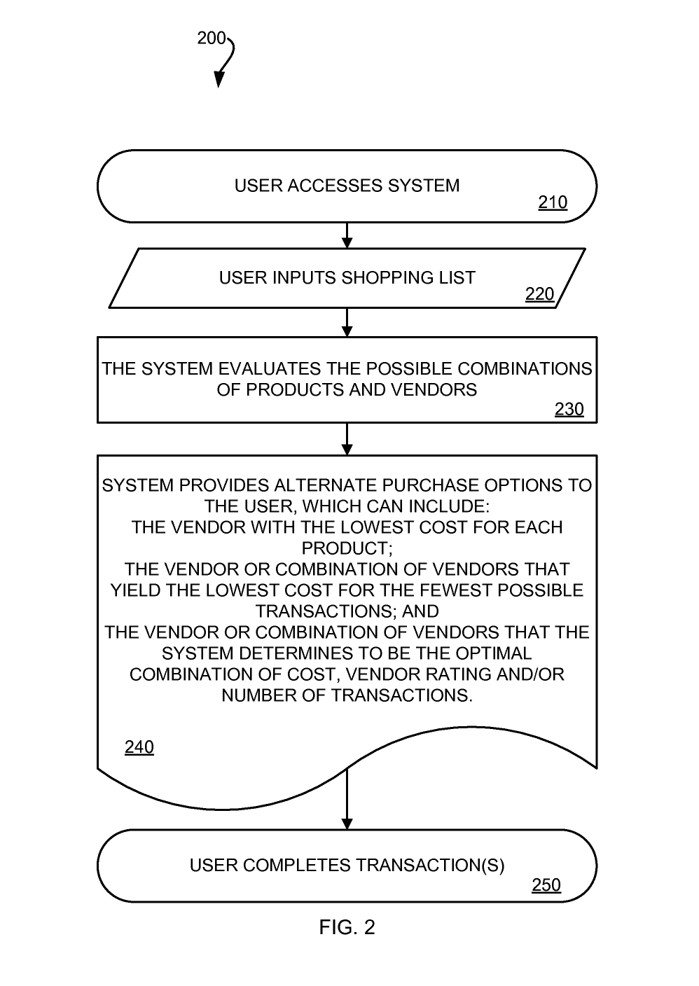

For example, USER A is interested in purchasing a plurality of different products online, but does not wish to shop for the items individually (i.e., “serially” or one at a time). Rather, USER A will save time by utilizing the system 130 to search for all of the desired items simultaneously (i.e., in parallel). USER A accesses the system 130 over the Internet from his or her home computer, laptop computer, mobile telephone or other device having Internet capability. Step 210 of FIG. 2. The system 130 is reached by entering a URL associated with the web page for the system 130 in a browser of the Internet enabled device 110 or 120. Note that the URL for the system 130 need not be typed in, but could also be read in by a device or smartphone, such as device 120, utilizing a camera of the device and associated software to read in a symbol or barcode (such as a QR code) that the software translates into a URL.

USER A inputs his or her shopping list into an online form of system 130. Step 220 of FIG. 2. In one particular embodiment of the invention, USER A first inputs his or her search terms into the online form and a search is performed, the results of which can, optionally, be further refined by USER A. In particular, USER A refines the result set to narrow the search results and assist USER A in selecting items that more precisely correspond to the items desired by USER A.

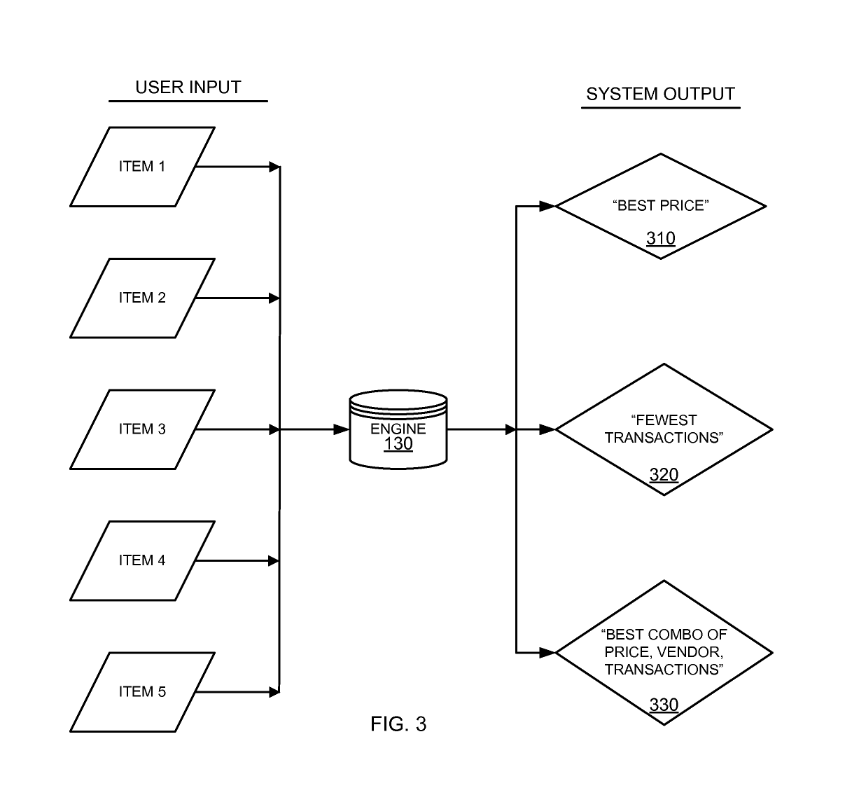

For example, USER A may be searching for five items (i.e., item 1, item 2, item 3, item 4, item 5 of FIG. 3). USER A enters five search terms into the online form of system 130 and hits the “search” or “go” soft button on a GUI of the Internet device 110 or 120 used by USER A. The search engine of system 130 searches the Internet for products being offered by the various online vendors 140₁ . . . 140ₙ, that match the search terms entered by USER A. Assume, for purposes of the present example, that one of the five search terms entered by USER A was “shirt”. The system 130 could return thousands of online vendors selling shirts. Consequently, the system 130 gives the user the option of further refining the search terms to narrow the results for each of the five search terms entered. For example, USER A can then enter further terms (or select further limiting terms from a menu or link), such as a particular brand, color and/or size of shirt to which the search results should be narrowed. USER A will be given the option of refining the searches for each of the five sets of search results. Once additional search criteria have been added, USER A can, again, select the “search” or “go” soft button to perform subset searches within the previous set of search results. If desired, the search query can be structured so that search terms can be deleted (i.e., “closed”) by selecting them, as well. In this way, the system 130 performs searches (iteratively, if desired) based on the inputs provided by USER A into the online form of system 130. Consequently, USER A can refine the search to be quite specific (i.e., Black, Large, Calvin Klein Shirt) for each of the five items on USER A's shopping list.

In operation, the system 130 searches all online sources, including vendor websites, marketplace websites and other websites from which products can be purchased online, for each product on USER A's shopping list, to identify sources from which each product on the shopping list is available. For each source from which the identified products are available, the system 130 compares certain predefined attributes, including, but not limited to, price, shipping cost and seller rating. Step 230 of FIG. 2. For example, once USER A has finished refining the search results provided by the search engine of system 130, the system 130 presents the consumer with a plurality of optimal alternate purchase options for the products on the shopping list, based on the predefined attributes (i.e., price, shipping cost, seller rating, etc.) and other criteria defined by the system 130. Step 240 of FIG. 2. Such optimal alternate purchase options can include, but are not limited to:

a) The single vendor or combination of vendors that offer(s) the lowest price and/or the lowest total price (i.e., the total price taking into account product price, available discounts and shipping costs) for each product on USER A's shopping list, regardless of the number of vendors involved (310 of FIG. 3). For example, this can be five different vendors (one for each of the five shopping list items) each of which offers the lowest total price for their respective item;

b) The single vendor or combination of vendors that offers the fewest possible (i.e., lowest number of) purchase transactions for ordering the five items on USER A's shopping list (320 of FIG. 3). For example, this option can offer an invoice or an optimized purchase option for a single vendor that offers all five items (i.e., a single transaction), instead of a purchase option having two vendors that, cumulatively, offer the five items at a lower total price, but in two separate transactions. If desired, however, lowest total price can be used to distinguish between vendors or combinations of vendors that offer the same number of transactions (i.e., if three vendors each sell all five items, the optimized purchase option will be prepared for the vendor that offers the five items at the lowest total price).

c) The vendor or combination of vendors that the system determines to be the most optimal combination of total price, vendor rating and/or total number of transactions (330 of FIG. 3). Alternately, the system can provide a purchase option optimizing only two of the above variables (i.e., best price for fewest number of transactions; best price from vendors having the highest ratings; fewest number of transactions from vendors having the highest ratings; etc.).

If USER A is not satisfied with the alternative purchase options presented by the system 130, USER A can elect to have the system 130 present additional purchase option alternatives. The system is programmed to vary the optimization criteria, based on a predefined sequence of optimization criteria, each time the consumer requests additional purchase option alternatives. Additionally, if desired, the system 130 can utilize customer history as a criteria. For example, USER A has purchased through the system 130 before, the system 130 can optimize the results by providing a greater weighting towards vendors that USER A has purchased from repeatedly, or to whom USER A has provided a favorable rating.

Once USER A selects one of the optimized alternative purchase options presented by the system 130, USER A will proceed with the purchase. Step 250 of FIG. 2. The purchase may either be accomplished by directing USER A to each of the vendor's websites or directly through the system, in which case the system will transmit the necessary consumer information to each of the vendor's websites on behalf of the consumer. In one particular embodiment of the invention, the system 130 transfers the information regarding the purchases to be made into the online “shopping cart” of each, respective vendor from which the USER A has decided to buy one of the items 1-5, and USER A concludes the purchase transactions outside of the system 130.

In another particular embodiment of the invention, if desired, USER A can input the shopping list, and narrow the results, using an appropriate form provided as part of a mobile application loaded on the Internet enabled mobile device 120, instead of using an online form at a website associated with the system 130. A system including the mobile application would function in much the same way as discussed hereinabove. However, the user would interact with the mobile application on the device 120, instead of directly with a website associated with the system 130, and the mobile application would, in turn, communicate with the system 130. In such an embodiment, USER A would enter items to be searched into the mobile application by typing the items or search terms into search fields of the mobile application or, if desired, by using the camera on their mobile device to scan the barcodes of items for which he or she wants to search when such barcodes are encountered. For example, the user could utilize the mobile application when they are visiting retail shops and would like to compare the prices in-store versus what is available for sale online. The information entered into the mobile application is then transmitted to the system 130, where the optimal alternate purchase options are calculated, as discussed elsewhere herein. Once calculated, the alternate purchase options are then transmitted back to the mobile application by the system 130, where the options are displayed for the user. The user then chooses the purchase option(s) that best suits them and completes the transaction(s), as described hereinabove.

The foregoing method and system presents one preferred embodiment of the present invention. It should be appreciated that there are many alternative embodiments within the scope of the present invention. For example, the predefined attributes compared by the system 130 in step 230, above can include any other attributes that can be discerned online, such as delivery time, purchase from domestic vendors only, etc., in addition to or in place of the attributes previously identified. In addition, the number of purchase option alternatives and/or the criteria utilized by the system to define the purchase option alternatives can be varied based on market factors or as otherwise determined by the system operators.

While the invention has been described, disclosed, illustrated and shown in various terms of certain embodiments or modifications, which it has presumed in practice, the scope of the invention is not intended to be, nor should it be deemed to be, limited thereby and such other modifications or embodiments as may be suggested by the teachings herein are particularly reserved, especially as they fall within the breadth and scope of the claims here appended.

I claim:

1. A system for facilitating multiple purchases online, comprising:
a device connected to the Internet, the device configured by software executed by a processor of the device to:
receive a list representing a plurality of items to be searched;
perform a search over the Internet for the plurality of items on the received list;
calculate, based on the search performed, a plurality of purchase options from one or more online vendors for the plurality of items on the received list; and
output the plurality of purchase options.

2. The system of claim 1, wherein the list includes a plurality of search terms.

3. The system of claim 2, wherein the device is additionally configured to refine the search performed, prior to outputting the plurality of purchase options.

4. The system of claim 1, wherein the search is performed for the plurality of items at one time.

5. The system of claim 1, wherein the device calculates one of the plurality of purchase options based on the lowest price found for each item of the plurality of items without regard to the number of vendors involved.

6. The system of claim 5, wherein the device calculates one of the plurality of purchase options based on the fewest possible transactions to obtain all of the items on the list.

7. The system of claim 6, wherein the device calculates one of the plurality of purchase options by optimizing the price and number of transactions for purchasing the list items.

8. The system of claim 6, wherein the device calculates one of the plurality of purchase options based on vendor ratings and optimizing the price and number of transactions for purchasing the list items.

9. The system of claim 1, wherein the device calculates one of the plurality of purchase options based on the fewest possible transactions to obtain all of the items on the list.

10. The system of claim 1, wherein the device calculates one of the plurality of purchase options by optimizing the price and number of transactions for purchasing the list items.

11. The system of claim 1, wherein the device is configured to execute purchases for the items in the list based on the selection of one of the purchase options by a user.

12. The system of claim 1, wherein after selecting a purchase option of said plurality of purchase options, a user concludes the purchase transactions with each vendor.

13. A method for facilitating multiple purchases online, comprising the steps of:
receiving a list representing a plurality of items to be searched;
searching the Internet for the plurality of items on the received list;
calculating, based on the search performed, a plurality of purchase options from one or more online vendors for the plurality of items on the received list; and
outputting the plurality of purchase options.

14. The method of claim 13, wherein the device is additionally configured to refine the search performed, prior to outputting the plurality of purchase options.

15. The method of claim 13, wherein the calculating step calculates one of the plurality of purchase options based on the lowest price found for each item of the plurality of items without regard to the number of vendors involved.

16. The method of claim 15, wherein the calculating step calculates one of the plurality of purchase options based on the fewest possible transactions to obtain all of the items on the list.

17. The method of claim 16, wherein the calculating step calculates one of the plurality of purchase options by optimizing at least the price and number of transactions for purchasing the list items.

18. The method of claim 13, wherein the calculating step calculates one of the plurality of purchase options based on the fewest possible transactions to obtain all of the items on the list.

19. The method of claim 13, wherein the calculating step calculates one of the plurality of purchase options by optimizing the price and number of transactions for purchasing the list items.

20. The method of claim 12, further comprising the step of executing purchases for the items in the list based on a purchase option selected by a user.
